(19) United States
(12) Patent Application Publication
(10) Pub. No.: US 2007/0202389 A1
(43) Pub. Date: Aug. 30, 2007

(54) Membrane electrode structure for polymer electrolyte fuel cell

(75) Inventors: Yoichi Asano, Wako-shi (JP); Shintaro Tanaka, Wako-shi (JP); Ryoichiro Takahashi, Wako-shi (JP); Takuma Yamawaki, Wako-shi (JP)

Correspondence Address: ARENT FOX PLLC, 1050 CONNECTICUT AVENUE, N.W., SUITE 400, WASHINGTON, DC, 20036, US

(73) Assignee: HONDA MOTOR CO., LTD.

(21) Appl. No.: 11/644,824

(22) Filed: Dec. 26, 2006

(30) Foreign Application Priority Data
Feb. 28, 2006 (JP) 2006-053669

(51) Int. Cl. H01M 4/94; H01M 4/96

(52) U.S. Cl. 429/44; 429/42

(57) ABSTRACT

A membrane electrode structure for a polymer electrolyte fuel cell capable of offering excellent power generation performance both in high humidity conditions and low humidity conditions. The membrane electrode structure for a polymer electrolyte fuel cell is composed of a solid polymer electrolyte membrane 2 having proton conductivity, a cathode electrode catalyst layer 3, an anode electrode catalyst layer 4 and gas diffusion layers 5, 6. The gas diffusion layers 5, 6 have through holes with a mean diameter of 15 to 45 μm and a specific surface area of 0.25 to 0.5 m²/g, and have a bulk density of 0.35 to 0.55 g/cm³. An intermediate layer 7 is provided between the cathode electrode catalyst layer 3 and the gas diffusion layer 5, and the intermediate layer 7 has through holes with a diameter of 0.01 to 10 μm and a volume of 3.8 to 7.0 μl/cm². The intermediate layer 7 is made of a water-repellent resin containing conductive particles.

### BACKGROUND OF THE INVENTION

1. Field of the Invention

The present invention relates to a membrane electrode structure for a polymer electrolyte fuel cell.

2. Description of the Related Art

While oil resources are being depleted, consumption of fossil fuels has caused serious environmental problems such as global warming. Under such circumstances, fuel cells have been attracting attention as a clean power source for electric motors which does not emit carbon dioxide, and have been widely developed and begun to be practically used in some fields. When installing such fuel cells in automobiles, polymer electrolyte fuel cells with a solid polymer electrolyte membrane are suitably used because they make it easier to obtain high voltage and large current.

Among such membrane electrode structures used for polymer electrolyte fuel cells, there is known a structure comprising a pair of electrode catalyst layers on both sides of a solid polymer electrolyte membrane having proton conductivity and a gas diffusion layer stacked on each of the electrode catalyst layers. The pair of electrode catalyst layers is composed of a catalyst such as platinum held on a catalyst carrier such as carbon black and is integrated with an ion conductive polymer binder. One of the electrode catalyst layers serves as a cathode electrode catalyst layer and the other serves as an anode electrode catalyst layer. Also, the gas diffusion layer is formed from, for example, carbon paper. The membrane electrode structure is formed into a polymer electrolyte fuel cell with a separator which also serves as a gas channel being stacked on the respective gas diffusion layers.

In the polymer electrolyte fuel cell, the anode electrode catalyst layer corresponds to a fuel electrode into which reducing gas such as hydrogen or methanol is introduced through the gas diffusion layer. The cathode electrode catalyst layer corresponds to an oxygen electrode into which oxidizing gas such as air or oxygen is introduced through the gas diffusion layer. With such a configuration, protons and electrons are generated from the reducing gas in the anode electrode catalyst layer by the action of the catalyst contained in the electrode catalyst layer. The protons are transferred to the electrode catalyst layer of the oxygen electrode side through the solid polymer electrolyte membrane. Then, the protons react with the oxidizing gas introduced into the oxygen electrode and electrons in the cathode electrode catalyst layer by the action of the catalyst contained in the electrode catalyst layer to produce water. Thus, by connecting the anode electrode catalyst layer and the cathode electrode catalyst layer with a conducting wire, a circuit is formed through which electrons generated in the anode electrode catalyst layer are transferred to the cathode electrode catalyst layer, making it possible to produce current.

In the membrane electrode structure, the protons move through the solid polymer electrolyte membrane with water. For this reason, in the polymer electrolyte fuel cell, the solid polymer electrolyte membrane must contain an appropriate amount of water, which is provided from, for example, the aforementioned reducing gas or oxidizing gas. However, when the humidity of the reducing gas or oxidizing gas is low, the polymer electrolyte fuel cell has a problem that sufficient power generation performance cannot be obtained.

On the other hand, in the polymer electrolyte fuel cell, water is generated in the cathode electrode catalyst layer of the membrane electrode structure with generation of power as described above. Therefore, when the polymer electrolyte fuel cell is continuously operated for a long time, the amount of water in the membrane electrode structure becomes excessive, which consequently blocks diffusion of the reducing gas or oxidizing gas and causes a problem that sufficient power generation performance cannot be obtained even in this case.

Various proposals have been made in order to solve the above problem. For example, a membrane electrode structure is known in which the gas diffusion layer on the cathode electrode catalyst layer side is divided into the first layer and the second layer thicker than the first layer along the thickness direction from the solid polymer electrolyte membrane side, and the average pore size of pores in the second layer is made larger than the average pore size of pores in the first layer. In the membrane electrode structure, the average specific surface area of carbon particles contained in the first layer is set to 100 to 1000 m²/g and the average specific surface area of carbon particles contained in the second layer is set to less than 100 m²/g (see Japanese Patent Laid-Open No. 2001-338655).

Also, a membrane electrode structure is known in which the high frequency peak of pore volume in pore distribution of the gas diffusion layer on the cathode electrode catalyst layer side is set to a pore size range of 10 to 30 μm and the sum of volumes of pores having a pore size larger than 30 μm is adjusted to 20% by volume or less based on the total pore volume (see Japanese Patent Laid-Open No. 2005-267902).

However, the above conventional arts have a disadvantage that it is difficult to obtain sufficient power generation performance both in high humidity conditions and low humidity conditions.

### SUMMARY OF THE INVENTION

An object of the present invention is to eliminate such a disadvantage and provide a membrane electrode structure for a polymer electrolyte fuel cell capable of offering excellent power generation performance both in high humidity conditions and low humidity conditions.

To achieve the object, the present invention provides a membrane electrode structure for a polymer electrolyte fuel cell comprising a solid polymer electrolyte membrane having proton conductivity, a cathode electrode catalyst layer provided on one side of the solid polymer electrolyte membrane, an anode electrode catalyst layer provided on the other side of the solid polymer electrolyte membrane, and a gas diffusion layer provided on a side of the respective electrode catalyst layers opposite from the solid polymer electrolyte membrane, wherein the gas diffusion layer has pores with a mean diameter of 15 to 45 μm and a specific surface area of 0.25 to 0.5 m²/g, which extends through the gas diffusion layer in the thickness direction, and has a bulk density of 0.35 to 0.55 g/cm³.

In the membrane electrode structure for a polymer electrolyte fuel cell of the present invention, the gas diffusion layer has pores extending through the layer in the thickness direction, and the pores have a mean diameter and a specific surface area in the aforementioned ranges. Further, in the membrane electrode structure for a polymer electrolyte fuel cell, the gas diffusion layers have a bulk density in the aforementioned range in total. As a result, in the membrane electrode structure for a polymer electrolyte fuel cell of the present invention, when the humidity of reducing gas or oxidizing gas is low, sufficient water is supplied to the solid polymer electrolyte membrane by diffusing the reducing gas or the oxidizing gas in the surface direction in the gas diffusion layer. On the other hand, when operation is continued for a long time, water is drained from the solid polymer electrolyte membrane to prevent accumulation of excessive water in the membrane electrode structure, allowing the reducing gas or oxidizing gas to be sufficiently diffused.

Accordingly, the membrane electrode structure for a polymer electrolyte fuel cell of the present invention is capable of offering excellent power generation performance both in high humidity conditions and low humidity conditions.

In any of the case when the mean diameter of the pores is less than 15 μm, the specific surface area of the pores is less than 0.25 m²/g, or when the bulk density of the gas diffusion layers is less than 0.35 g/cm³ in total, the reducing gas or oxidizing gas cannot be diffused in the surface direction in the gas diffusion layer. As a result, water cannot be drained from the solid polymer electrolyte membrane.

On the other hand, in any of the case when the mean diameter of the pores is more than 45 μm, the specific surface area of the pores is more than 0.5 m²/g, or when the bulk density of the gas diffusion layers is more than 0.55 g/cm³ in total, excessive water is drained excessively from the solid polymer electrolyte membrane. As a result, sufficient water cannot be reserved in the membrane electrode structure.

Also, preferably the membrane electrode structure for a polymer electrolyte fuel cell of the present invention further comprises an intermediate layer at least part of which is embedded in the gas diffusion layer formed between the cathode electrode catalyst layer and the gas diffusion layer provided on the cathode electrode catalyst layer, wherein the intermediate layer has pores with a diameter of 0.01 to 10 μm and a volume of 3.8 to 7.0 μl/cm², which extends through the intermediate layer in the thickness direction.

Since the pores extending through the intermediate layer in the thickness direction have a diameter of 0.01 to 10 μm, water and the oxidizing gas pass through the layer easily. Thus, as the pores in the intermediate layer have a volume of 3.8 to 7.0 μl/cm², the intermediate layer can serve as a medium through which the oxidizing gas in the gas diffusion layer is supplied to the cathode electrode catalyst layer and through which water in the cathode electrode catalyst layer is discharged to the gas diffusion layer.

Accordingly, the membrane electrode structure for a polymer electrolyte fuel cell of the present invention comprising the intermediate layer is capable of offering higher power generation performance both in high humidity conditions and low humidity conditions.

When the pores in the intermediate layer have a volume of less than 3.8 μl/cm², water and the oxidizing gas are difficult to pass through the layer, and sufficient advantageous effect of the medium may not be obtained. On the other hand, when the pores have a volume of more than 7.0 μl/cm², the effect of discharging water in the cathode electrode catalyst layer to the gas diffusion layer is excessive, possibly making it difficult to reserve sufficient water in the membrane electrode structure.

For the intermediate layer, for example, a material made of a water-repellent resin containing conductive particles may be used.

The intermediate layer may be provided between the cathode electrode catalyst layer and the gas diffusion layer provided on the cathode electrode catalyst layer, or may also be provided between the anode electrode catalyst layer and the gas diffusion layer provided on the anode electrode catalyst layer.

### BRIEF DESCRIPTION OF THE DRAWINGS

FIG. 1 is a schematic cross-sectional view illustrating a configuration of the membrane electrode structure of the present invention;

FIG. 2 is a schematic cross-sectional view illustrating a configuration of a fuel cell using the membrane electrode structure shown in FIG. 1; and

FIG. 3 is a graph showing the relationship between the volume of pores in the intermediate layer on the cathode side of the membrane electrode structure of the present invention and terminal voltage.

### DETAILED DESCRIPTION OF THE PREFERRED EMBODIMENTS

Embodiments of the present invention are now described in more detail with reference to the attached drawings.

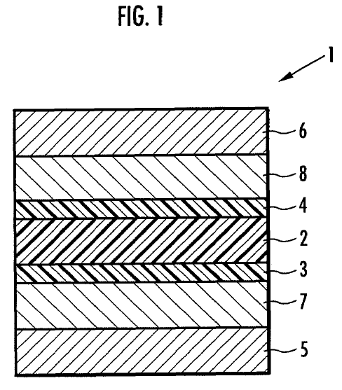

As FIG. 1 shows, the membrane electrode structure 1 of this embodiment comprises a cathode electrode catalyst layer 3 on one side of a solid polymer electrolyte membrane 2 having proton conductivity and an anode electrode catalyst layer 4 on the other side thereof. Gas diffusion layers 5, 6 are provided on a side of the electrode catalyst layers 3, 4 opposite from the solid polymer electrolyte membrane 2. Also, intermediate layers 7, 8 are each provided between the electrode catalyst layers 3, 4 and the gas diffusion layers 5, 6.

The solid polymer electrolyte membrane 2 belongs to cation exchange resins, and a polymer having proton conductivity formed into a film may be used therefor. Examples of such cation exchange resins include sulfonated vinyl polymers such as polystyrene sulfonic acid; heat resistant polymers into which a sulfonate group or a phosphate group is introduced, such as perfluoroalkylsulfonic acid polymers, perfluoroalkylcarboxylic polymers, polybenzimidazole and polyether ether ketone; and polymers containing rigid polyphenylene obtained by polymerizing an aromatic compound comprising a phenylene chain as a main component into which a sulfonate group is introduced.

The electrode catalyst layers 3, 4 are composed of a catalyst such as platinum held on a catalyst carrier such as carbon black and are integrated with an ion conductive polymer binder. Such electrode catalyst layers 3, 4 can be formed, for example, by applying paste obtained by mixing a catalyst such as platinum held on a catalyst carrier such as carbon black and a solution of a resin which is the same type as the solid polymer electrolyte membrane 2 to a film of, for example, tetrafluoroethylene so that the amount of the catalyst reaches a pre-determined level, and then transferring the paste to both sides of the solid polymer electrolyte membrane 2.

The gas diffusion layers 5, 6 have pores (not shown) extending through the layers in the thickness direction and have a bulk density of 0.35 to 0.55 g/cm³ in total. Also, the pores extending through the layer in the thickness direction have a mean diameter of 15 to 45 μm and a specific surface area of 0.25 to 0.5 m²/g.

For such gas diffusion layers 5, 6, water repellent-treated carbon paper having pores with a mean diameter and a specific surface area in the aforementioned ranges and extending through the layer in the thickness direction and having a bulk density in the aforementioned range may be used. The water repellent treatment can be performed, for example, by impregnating the carbon paper with a solution of a tetrafluoroethylene-tetrafluoropropylene copolymer and then heat treating.

Part of the intermediate layers 7, 8 is embedded in the gas diffusion layers 5, 6, and the intermediate layers have pores with a diameter of 0.01 to 10 μm and a volume of 4.0 to 7.0 μl/cm², which extend through the layer in the thickness direction. Such intermediate layers 7, 8 can be formed, for example, by applying paste obtained by mixing carbon powder having both electron conductivity and pore forming properties, a water-repellent resin such as tetrafluoroethylene and an organic solvent such as ethylene glycol to the gas diffusion layers 5, 6 and then heat treating.

The membrane electrode structure 1 can be formed by transferring the electrode catalyst layers 3, 4 to both sides of the solid polymer electrolyte membrane 2 as described above and then stacking the gas diffusion layers 5, 6 on which the intermediate layers 7, 8 are formed on the electrode catalyst layers 3, 4 on the side of the intermediate layers 7, 8 and integrally joining by thermocompression bonding.

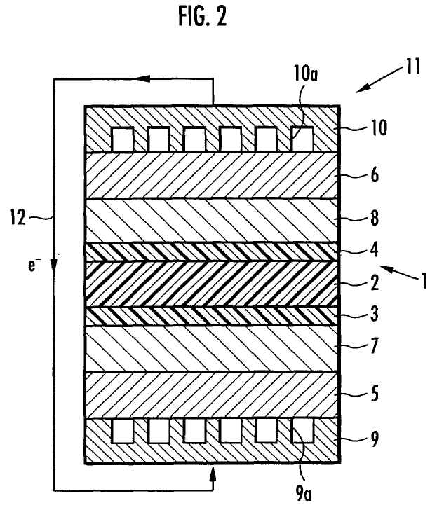

The membrane electrode structure 1 can be formed into a fuel cell 11 by stacking separators 9, 10 on the gas diffusion layers 5, 6 as shown in FIG. 2. For separators 9, 10, carbon paper having a straight groove 9a, 10a, for example, can be used, which is stacked on the gas diffusion layers 5, 6 on the side of the straight groove 9a, 10a.

In the fuel cell 11 shown in FIG. 2, the straight groove 10a of the separator 10 on the anode side serves as a channel through which reducing gas such as hydrogen or methanol is introduced and the straight groove 9a of the separator 9 on the cathode side serves as a channel through which oxidizing gas such as air or oxygen is introduced. With such a configuration, first, the reducing gas introduced through the channel 10a is supplied to the anode electrode catalyst layer 4 through the gas diffusion layer 6 and the intermediate layer 8 on the anode side. In the anode electrode catalyst layer 4, protons and electrons are generated from the reducing gas by the action of the catalyst and the protons are transferred to the cathode electrode catalyst layer 3 through the solid polymer electrolyte membrane 2.

Next, on the cathode side, the oxidizing gas introduced through the channel 9a is supplied to the cathode electrode catalyst layer 3 through the gas diffusion layer 5 and the intermediate layer 7, and the protons react with the oxidizing gas and electrons in the cathode electrode catalyst layer 3 by the action of the catalyst to produce water. Thus, by connecting separators 9, 10 with a conducting wire, a circuit 12 is formed through which electrons generated on the anode side are transferred to the cathode side, making it possible to produce current.

Since the protons move through the solid polymer electrolyte membrane 2 with water, the membrane electrode structure 1 must contain an appropriate amount of water. Such water can be supplied to the membrane electrode structure 1, for example, by humidifying the reducing gas and the oxidizing gas.

Here, the fuel cell 11 is in a low humidity condition immediately after the start of operation because of shortage of water supplied to the membrane electrode structure 1 from the reducing gas and the oxidizing gas. When operated for a long time, the fuel cell 11 will get into a high humidity condition due to excessive water, because water is generated in the cathode electrode catalyst layer 3. Thus, there is fear that sufficient power generation performance cannot be obtained either in low humidity conditions or high humidity conditions.

However, in the membrane electrode structure 1, the gas diffusion layers 5, 6 have pores extending through the layer in the thickness direction and have a bulk density of 0.35 to 0.55 g/cm³ in total. And the pores have a mean diameter of 15 to 45 μm and a specific surface area of 0.25 to 0.5 m²/g.

Also, in the membrane electrode structure 1, the intermediate layers 7, 8 disposed between the electrode catalyst layers 3, 4 and the gas diffusion layers 5, 6 have pores extending through the layer in the thickness direction, which have a diameter of 0.01 to 10 μm and a volume of 4.0 to 7.0 μl/cm².

Accordingly, in a low humidity condition, for example, immediately after the start of operation, the reducing gas or the oxidizing gas is diffused in the surface direction in the gas diffusion layers 5, 6 and led to the solid polymer electrolyte membrane 2 through the intermediate layers 7, 8, providing enough water to the solid polymer electrolyte membrane 2. On the other hand, in a high humidity condition in the case of, for example, continuing operation for a long time, water near the solid polymer electrolyte membrane 2 is led to the gas diffusion layers 5, 6 through the intermediate layers 7, 8 and drained through the gas diffusion layers 5, 6. This prevents the amount of water from increasing too much in the membrane electrode structure 1, allowing the reducing gas or the oxidizing gas to be sufficiently diffused in the gas diffusion layers 5, 6.

Accordingly, the membrane electrode structure 1 is capable of offering excellent power generation performance both in high humidity conditions and low humidity conditions.

Examples and Comparative Examples of the present invention are now described.

### EXAMPLE 1

In this Example, first carbon paper was impregnated with a 10% by weight solution of a tetrafluoroethylene-tetrafluoropropylene copolymer, and then heat treatment was performed at 380° C. for 30 minutes to form gas diffusion layers 5, 6. The carbon paper has a mass per unit area of 80 g/m², a thickness of 190 μm, a bulk density of 0.42 g/cm³ and pores extending through the paper in the thickness direction (hereinafter abbreviated as through holes). The mean diameter and the specific surface area of the through holes were measured by the bubble point method specified in JIS K 3832 using a mercury porosimeter (made by PMI, product name: PermPorometer), and as a result, the mean diameter was 21 μm and the specific surface area was 0.41 m²/g.

Next, 10 g of vapor growth carbon (available from SHOWA DENKO K.K., VGCF®) which is a carbon powder having both electron conductivity and pore forming properties, 10 g of tetrafluoroethylene powder (available from ASAHI GLASS CO., LTD., product name: Fluon L170J) and 180 g of ethylene glycol were mixed with stirring in a ball mill to prepare a mixed paste. Then, the mixed paste was applied to the gas diffusion layer 5 on the cathode side by screen printing so that the dry weight was 1.8 mg/cm², and the heat treatment was performed at 380° C. for 30 minutes to form an intermediate layer 7 on the cathode side. Part of the intermediate layer 7 is embedded in the gas diffusion layer 5, and the intermediate layer 7 have pores with a diameter of 0.01 to 10 μm, which extends through the layer in the thickness direction (hereinafter abbreviated as through holes). The volume of the through holes measured by the bubble point method specified in JIS K 3832 using the mercury porosimeter were 4.9 μl/cm².

Next, a mixed paste was prepared in quite the same manner as in the case of preparing the intermediate layer 7 except that carbon powder (available from Cabot Corporation, product name: Vulcan XC72) which is a conductive material also having pore forming properties was used instead of the vapor growth carbon. Then, an intermediate layer 8 was formed on the gas diffusion layer 6 on the anode side in quite the same manner as in the case of preparing the intermediate layer 7 except that the mixed paste was applied to the layer by screen printing so that the dry weight was 2.0 mg/cm². Part of the intermediate layer 8 on the anode side is embedded in the gas diffusion layer 6, and the intermediate layer 8 has through holes with a diameter of 0.01 to 10 μm. The volume of the through holes measured by the bubble point method specified in JIS K 3832 using the mercury porosimeter were 2.4 μl/cm².

In the next step, 120 g platinum supported carbon particles (available from Tanaka Precious Metals) and 420 g of a 20% solution of an ion conductive polymer (available from DuPont, product name: Nafion® DE2021) were mixed with stirring in a ball mill to prepare a mixed paste containing a catalyst. Subsequently, the mixed paste containing catalyst was applied to a polytetrafluoroethylene sheet by screen printing so that the platinum content was 0.5 mg/cm², and then heat treatment was performed at 120° C. for 60 minutes to form two sheets with an electrode catalyst layer (hereinafter abbreviated as electrode catalyst sheet).

Next, each of the electrode catalyst sheets was bonded to both sides of a solid polymer electrolyte membrane (available from DuPont, product name: Nafion® 112) 2 on the electrode catalyst layer side by thermocompression bonding under conditions of 120° C. and a contact pressure of 4.0 MPa for 10 minutes. The polytetrafluoroethylene sheet was then removed, and by a decal method for transferring the electrode catalyst layer to the solid polymer electrolyte membrane 2, the cathode electrode catalyst layer 3 was formed on one side of the solid polymer electrolyte membrane 2 and the anode electrode catalyst layer 4 on the other.

Then, the gas diffusion layers 5, 6 on which the intermediate layers 7, 8 were formed were stacked on the solid polymer electrolyte membrane 2 on which the electrode catalyst layers 3, 4 were formed so that the intermediate layer 7 was joined with the electrode catalyst layer 3 and the intermediate layer 8 was joined with the electrode catalyst layer 4, and thermocompression bonding was performed at 140° C. at a contact pressure of 3.0 MPa for 5 minutes to prepare the membrane electrode structure 1 shown in FIG. 1.

Subsequently, separators 9, 10 were stacked on the gas diffusion layers 5, 6 of the membrane electrode structure 1 to form the fuel cell 11 shown in FIG. 2, and hydrogen was passed through the channel 10a on the anode side and air was passed through the channel 9a on the cathode side. At this stage, with setting the area of the electrode section of the membrane electrode structure 1 to 36 cm², the cell temperature at the gas introduction section to 72° C., the relative humidity at the gas introduction section to 100% RH on the anode side and 100% RH on the cathode, the terminal voltage was measured under a condition of 1 A/cm² to evaluate power generation performance in high humidity conditions. Further, with setting the area of the electrode section of the membrane electrode structure 1 to 36 cm², the cell temperature at the gas introduction section to 72° C., the relative humidity at the gas introduction section to 29% RH on the anode side and 29% RH on the cathode, the terminal voltage was measured under a condition of 1 A/cm² to evaluate power generation performance in low humidity conditions. The results are shown in Table 1.

### EXAMPLE 2

In this Example, the membrane electrode structure 1 shown in FIG. 1 was prepared in quite the same manner as in Example 1 except that carbon paper having a mass per unit area of 85 g/m², a thickness of 185 μm and a bulk density of 0.46 g/cm³ was used instead of the carbon paper used in Example 1.

The mean diameter and the specific surface area of the through holes in the carbon paper and the volume of the through holes in the intermediate layers 7, 8 were measured in quite the same manner as in Example 1, and the power generation performance of the membrane electrode structure 1 in high humidity conditions and low humidity conditions was evaluated in quite the same manner as in Example 1. The results are shown in Table 1.

### EXAMPLE 3

In this Example, the membrane electrode structure 1 shown in FIG. 1 was prepared in quite the same manner as in Example 1 except that carbon paper having a mass per unit area of 85 g/m², a thickness of 185 μm and a bulk density of 0.41 g/cm³ was used instead of the carbon paper used in Example 1 and the coating amount of the mixed paste was adjusted to 2.5 mg/cm² in dry weight when forming the intermediate layer 7.

The mean diameter and the specific surface area of the through holes in the carbon paper and the volume of the through holes in the intermediate layers 7, 8 were measured in quite the same manner as in Example 1, and the power generation performance of the membrane electrode structure 1 in high humidity conditions and low humidity conditions was evaluated in quite the same manner as in Example 1. The results are shown in Table 1.

### EXAMPLE 4

In this Example, the membrane electrode structure 1 shown in FIG. 1 was prepared in quite the same manner as in Example 1 except that carbon paper having a mass per unit area of 71 g/m², a thickness of 190 μm and a bulk density of 0.46 g/cm³ was used instead of the carbon paper used in Example 1.

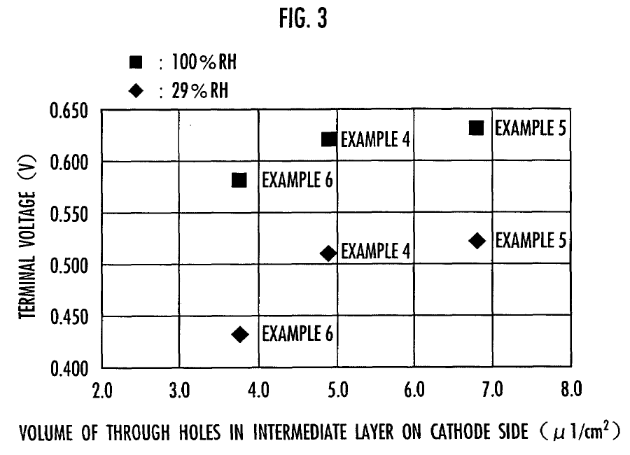

The mean diameter and the specific surface area of the through holes in the carbon paper and the volume of the through holes in the intermediate layers 7, 8 were measured in quite the same manner as in Example 1, and the power generation performance of the membrane electrode structure 1 in high humidity conditions and low humidity conditions was evaluated in quite the same manner as in Example 1. The results are shown in Table 1 and FIG. 3.

### EXAMPLE 5

In this Example, the membrane electrode structure 1 shown in FIG. 1 was prepared in quite the same manner as in Example 1 except that carbon paper having a mass per unit area of 71 g/m², a thickness of 190 μm and a bulk density of 0.46 g/cm³ was used instead of the carbon paper used in Example 1 and the coating amount of the mixed paste was adjusted to 2.5 mg/cm² in dry weight when forming the intermediate layer 7.

The mean diameter and the specific surface area of the through holes in the carbon paper and the volume of the through holes in the intermediate layers 7, 8 were measured in quite the same manner as in Example 1, and the power generation performance of the membrane electrode structure 1 in high humidity conditions and low humidity conditions was evaluated in quite the same manner as in Example 1. The results are shown in Table 1 and FIG. 3.

### EXAMPLE 6

The membrane electrode structure 1 shown in FIG. 1 was prepared in quite the same manner as in Example 1 except that carbon paper having a mass per unit area of 71 g/m², a thickness of 190 μm and a bulk density of 0.46 g/cm³ was used instead of the carbon paper used in Example 1 and a mixture of 5 g of the vapor growth carbon used in Example 1 and 5 g of milled fiber with a fiber diameter of 7 μm was used instead of 10 g of the vapor growth carbon used in Example 1 when forming the intermediate layer 7.

The mean diameter and the specific surface area of the through holes in the carbon paper and the volume of the through holes in the intermediate layers 7, 8 were measured in quite the same manner as in Example 1, and the power generation performance of the membrane electrode structure 1 in high humidity conditions and low humidity conditions was evaluated in quite the same manner as in Example 1. The results are shown in Table 1 and FIG. 3.

### COMPARATIVE EXAMPLE 1

In this Comparative Example, the membrane electrode structure 1 shown in FIG. 1 was prepared in quite the same manner as in Example 1 except that carbon paper having a mass per unit area of 58 g/m², a thickness of 190 μm and a bulk density of 0.31 g/cm³ was used instead of the carbon paper used in Example 1.

The mean diameter and the specific surface area of the through holes in the carbon paper and the volume of the through holes in the intermediate layers 7, 8 were measured in quite the same manner as in Example 1, and the power generation performance of the membrane electrode structure 1 in high humidity conditions and low humidity conditions was evaluated in quite the same manner as in Example 1. The results are shown in Table 1.

### COMPARATIVE EXAMPLE 2

In this Comparative Example, the membrane electrode structure 1 shown in FIG. 1 was prepared in quite the same manner as in Example 1 except that carbon paper having a mass per unit area of 62 g/m², a thickness of 190 μm and a bulk density of 0.31 g/cm³ was used instead of the carbon paper used in Example 1.

The mean diameter and the specific surface area of the through holes in the carbon paper and the volume of the through holes in the intermediate layers 7, 8 were measured in quite the same manner as in Example 1, and the power generation performance of the membrane electrode structure 1 in high humidity conditions and low humidity conditions was evaluated in quite the same manner as in Example 1. The results are shown in Table 1.

### COMPARATIVE EXAMPLE 3

In this Comparative Example, the membrane electrode structure 1 shown in FIG. 1 was prepared in quite the same manner as in Example 1 except that carbon paper having a mass per unit area of 75 g/m², a thickness of 190 μm and a bulk density of 0.42 g/cm³ was used instead of the carbon paper used in Example 1.

The mean diameter and the specific surface area of the through holes in the carbon paper and the volume of the through holes in the intermediate layers 7, 8 were measured in quite the same manner as in Example 1, and the power generation performance of the membrane electrode structure 1 in high humidity conditions and low humidity conditions was evaluated in quite the same manner as in Example 1. The results are shown in Table 1.

### COMPARATIVE EXAMPLE 4

In this Comparative Example, the membrane electrode structure 1 shown in FIG. 1 was prepared in quite the same manner as in Example 1 except that carbon paper having a mass per unit area of 78 g/m², a thickness of 190 μm and a bulk density of 0.41 g/cm³ was used instead of the carbon paper used in Example 1.

The mean diameter and the specific surface area of the through holes in the carbon paper and the volume of the through holes in the intermediate layers 7, 8 were measured in quite the same manner as in Example 1, and the power generation performance of the membrane electrode structure 1 in high humidity conditions and low humidity conditions was evaluated in quite the same manner as in Example 1. The results are shown in Table 1.

TABLE 1

| | | | | volume of | | | |
|---|---|---|---|---|---|---|---|
| | gas diffusion layer | | | through hole in | | | |
| | mean | specific | | intermediate layer | | terminal voltage | |
| | diameter of | surface area | bulk | | cathode | low | high |
| | through | of through | density | anode side | side | humidity | humidity |
| | hole (μm) | hole (m²/g) | (g/cm³) | (μl/cm²) | (μl/cm²) | (V) | (V) |
| Ex. 1 | 21.0 | 0.41 | 0.42 | 2.4 | 4.9 | 0.533 | 0.639 |
| Ex. 2 | 19.0 | 0.33 | 0.46 | 2.4 | 4.9 | 0.502 | 0.629 |
| Ex. 3 | 19.0 | 0.33 | 0.46 | 2.4 | 6.8 | 0.541 | 0.652 |
| Ex. 4 | 15.8 | 0.46 | 0.37 | 2.4 | 4.9 | 0.511 | 0.621 |
| Ex. 5 | 15.8 | 0.46 | 0.37 | 2.4 | 6.8 | 0.521 | 0.632 |
| Ex. 6 | 15.8 | 0.46 | 0.37 | 2.4 | 3.8 | 0.432 | 0.581 |
| Com. Ex. 1 | 7.8 | 0.96 | 0.31 | 2.4 | 4.9 | 0.373 | 0.558 |
| Com. Ex. 2 | 22.9 | 0.82 | 0.33 | 2.4 | 4.9 | 0.418 | 0.573 |
| Com. Ex. 3 | 18.0 | 0.72 | 0.39 | 2.4 | 4.9 | 0.421 | 0.567 |
| Com. Ex. 4 | 7.8 | 0.49 | 0.41 | 2.4 | 4.9 | 0.389 | 0.571 |

Table 1 clearly shows that the membrane electrode structures 1 of Examples 1 to 6 in which the through holes in the gas diffusion layers 5, 6 have a mean diameter of 15.8 to 21 μm and a specific surface area of 0.33 to 0.46 m²/g and the gas diffusion layers 5, 6 have a bulk density of 0.37 to 0.46 g/cm³ are capable of offering power generation performance both in high humidity conditions and low humidity conditions higher than that of the membrane electrode structures 1 of Comparative Examples 1 to 4.

Referring now to Examples 4 to 6 in which the mean diameters and the specific surface areas of the through holes in the gas diffusion layers 5, 6 and the bulk densities of the gas diffusion layers 5, 6 are the same, Table 1 and FIG. 3 clearly show that the membrane electrode structures 1 of Examples 4, 5 in which the volume of the through holes in the intermediate layer 7 on the cathode side is more than 4.0 μl/cm² are capable of offering power generation performance higher than that of the membrane electrode structure 1 of Example 6 in which the volume of the through holes in the intermediate layer 7 on the cathode side is less than 4.0 μl/cm². This obviously shows that the volume of the through holes in the intermediate layer 7 on the cathode side is preferably adjusted to 4.0 μl/cm² or more.

What is claimed is:

1. A membrane electrode structure for a polymer electrolyte fuel cell comprising a solid polymer electrolyte membrane having proton conductivity, a cathode electrode catalyst layer provided on one side of the solid polymer electrolyte membrane, an anode electrode catalyst layer provided on the other side of the solid polymer electrolyte membrane, and a gas diffusion layer provided on a side of the respective electrode catalyst layers opposite from the solid polymer electrolyte membrane,
wherein the gas diffusion layer has pores with a mean diameter of 15 to 45 μm and a specific surface area of 0.25 to 0.5 m²/g, which extend through the gas diffusion layer in the thickness direction, and has a bulk density of 0.35 to 0.55 g/cm³.

2. The membrane electrode structure for a polymer electrolyte fuel cell according to claim 1,
wherein the pores extending through the gas diffusion layer in the thickness direction have a mean diameter of 15.8 to 21 μm.

3. The membrane electrode structure for a polymer electrolyte fuel cell according to claim 1,
wherein the pores extending through the gas diffusion layer in the thickness direction have a specific surface area of 0.33 to 0.46 m²/g.

4. The membrane electrode structure for a polymer electrolyte fuel cell according to claim 1,
wherein the gas diffusion layer has a bulk density of 0.37 to 0.46 g/cm³.

5. The membrane electrode structure for a polymer electrolyte fuel cell according to claim 1,
wherein the gas diffusion layer comprises water repellent-treated carbon paper.

6. The membrane electrode structure for a polymer electrolyte fuel cell according to claim 1,
further comprising an intermediate layer at least part of which is embedded in the gas diffusion layer formed between the cathode electrode catalyst layer and the gas diffusion layer provided on the cathode electrode catalyst layer,
wherein the intermediate layer has pores with a diameter of 0.01 to 10 μm and a volume of 3.8 to 7.0 μl/cm², which extends through the intermediate layer in the thickness direction.

7. The membrane electrode structure for a polymer electrolyte fuel cell according to claim 6,
wherein the intermediate layer comprises a water repellent resin containing conductive particles.

8. The membrane electrode structure for a polymer electrolyte fuel cell according to claim 7,
wherein the conductive particles are carbon powder.

9. The membrane electrode structure for a polymer electrolyte fuel cell according to claim 7,
wherein the water-repellent resin is tetrafluoroethylene.
